(19) United States
(12) Patent Application Publication
(10) Pub. No.: US 2024/0111742 A1
(43) Pub. Date: Apr. 4, 2024

(54) MANAGEMENT DEVICE, MANAGEMENT METHOD, AND RECORDING MEDIUM

(71) Applicant: NEC Corporation, Minato-ku Tokyo (JP)

(72) Inventor: Ryo SHIBASAKI, Tokyo (JP)

(73) Assignee: NEC Corporation, Minato-ku Tokyo (JP)

(21) Appl. No.: 17/769,150

(22) PCT Filed: Nov. 9, 2020
(86) PCT No.: PCT/JP2020/041664

§ 371 Date: Apr. 14, 2022

(30) Foreign Application Priority Data
Nov. 11, 2019 (JP) 2019-203665

(51) Int. Cl. G06F 16/22; H04L 51/08; H04L 51/42

(52) U.S. Cl. CPC G06F 16/22; H04L 51/08; H04L 51/42

(57) ABSTRACT

This management device is provided with: a division processing unit for dividing a received email into a body and an attached file; a storage processing unit for storing the body, the attached file, and email structure information indicating the email structure of the email in a storage unit; a reference information registration processing unit for generating reference information in which link information indicating the storage destination of the divided email is associated with a related email related to the email, and storing the reference information in a reference information storage unit; a request processing unit for accepting an operation request with respect to the stored email; and an operation processing unit for performing operation processing to move, delete, search, or display the content of the email, based on the operation request.

### TECHNICAL FIELD

The present disclosure relates to an email management device and the like.

### BACKGROUND ART

An example of a method for searching for emails at a high speed includes use of an index. However, the email server manages one or a plurality of emails in one file. Therefore, the email server is required to update the index of the body or the attached file of the email according to the movement or deletion of the email. In the update operation, it is necessary to analyze the email content, and as a result, the processing amount accompanying the update of the index increases, and it takes time.

Depending on the update frequency of the index, inconsistency occurs between the content of the index and the entity of the email stored on the email server. When the email is moved or deleted, there is no information to associate the email with the relevant email, so that tracking is difficult.

In PTL 1, a specific character string is added to a subject in order to detect relevance of an email. Therefore, when a specific character is information indicating relevance unintentionally, the relevance may be erroneously determined. PTL 2 discloses an email management device that classifies and manages an email body and an attached file of an email received via a network and enables individual search of the email body and the attached file.

### CITATION LIST

### Patent Literature

[PTL 1] JP 2002-163213 A
[PTL 2] JP 2011-070490 A

### SUMMARY OF INVENTION

### Technical Problem

As described above, there is a demand for a management device that suppresses the processing amount of updating the index while maintaining the search performance for an email related to an email.

An object of the present disclosure is to provide a management device and the like capable of solving the above problems.

### Solution to Problem

A management device according to an aspect of the present disclosure includes a division processing unit that divides a received email into a body and an attached file, a storage processing unit that stores the body, the attached file, and email structure information indicating an email structure of the email in a storage unit, a reference information registration processing unit that generates reference information in which link information indicating a storage destination of the divided email is associated with a related email related to the email, and stores the reference information in a reference information storage unit, a request processing unit that accepts an operation request for the stored email, and an operation processing unit that performs an operation of moving, deleting, searching for, or displaying a content of the stored email based on the operation request.

A management method according to an aspect of the present disclosure includes dividing a received email into a body and an attached file, storing the body, the attached file, and email structure information indicating an email structure of the email, generating and storing reference information in which link information indicating a storage destination of the divided email is associated with a related email related to the email, accepting an operation request for the stored email, and performing an operation of moving, deleting, searching for, or displaying a content of the stored email based on the operation request.

A recording medium according to an aspect of the present disclosure storing a program causing a computer to execute dividing a received email into a body and an attached file, storing the body, the attached file, and email structure information indicating an email structure of the email, generating and storing reference information in which link information indicating a storage destination of the divided email is associated with a related email related to the email, accepting an operation request for the stored email, and performing an operation of moving, deleting, searching for, or displaying a content of the stored email based on the operation request.

### Advantageous Effects of Invention

According to the management device of the present disclosure, it is possible to suppress the processing amount of updating the index while maintaining the search performance for an email related to an email.

### BRIEF DESCRIPTION OF DRAWINGS

FIG. 1 is a block diagram illustrating a configuration of a management device 100 according to a first example embodiment.

FIG. 2 is a diagram illustrating an example of reference information stored in a reference information storage unit 105.

FIG. 3 is a flowchart illustrating an example of email storage processing by the management device 100.

FIG. 4 is a flowchart illustrating an example of an email operation process by the management device 100.

FIG. 5 is a diagram illustrating an example of changing reference information related to an email movement.

FIG. 6 is a diagram illustrating an example of changing reference information related to an email deletion.

FIG. 7 is a block diagram illustrating an example of a configuration of a management device 200 according to a second example embodiment.

FIG. 8 is a flowchart illustrating an example of email storage processing by the management device 200.

FIG. 9 is a block diagram illustrating an example of a configuration of a management device 300 according to a third example embodiment.

FIG. 10 is a diagram illustrating a hardware configuration by a computer.

### EXAMPLE EMBODIMENT

### First Example Embodiment

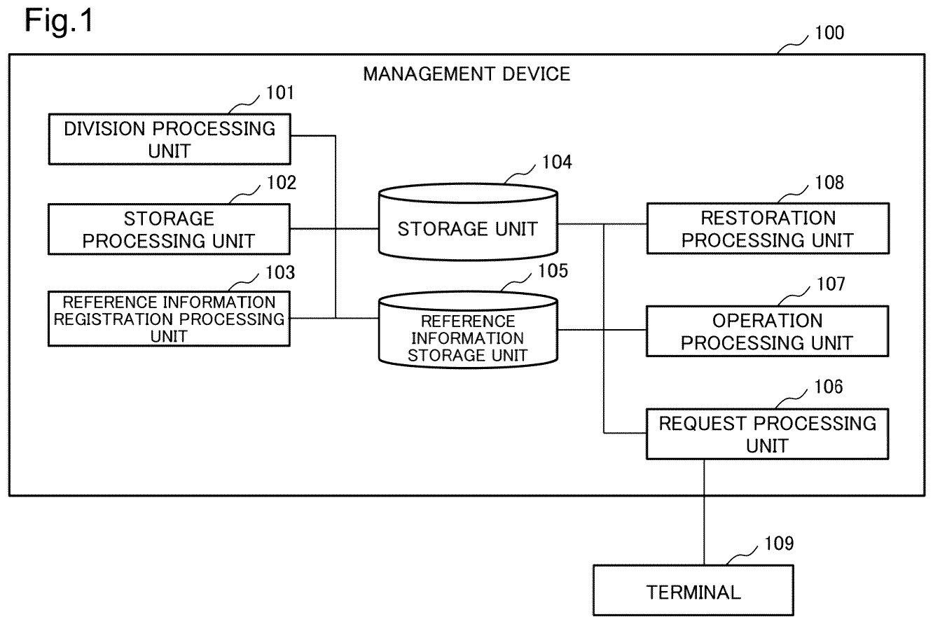

A management device according to an aspect of the first example embodiment will be described with reference to the drawings. FIG. 1 is a block diagram illustrating a configuration of a management device 100 according to the first example embodiment. As illustrated in FIG. 1, the management device 100 includes a division processing unit 101, a storage processing unit 102, a reference information registration processing unit 103, a storage unit 104, a reference information storage unit 105, a request processing unit 106, an operation processing unit 107, and a restoration processing unit 108. Further, the management device 100 is communicably connected to a terminal 109. An example of the management device 100 is an email server or an emailer. The storage unit 104 and the reference information storage unit 105 are, for example, storage devices. The storage unit 104 and the reference information storage unit 105 may be included in the same storage device. Hereinafter, an example in which the management device 100 is applied to an email server will be described.

The division processing unit 101 analyzes an email (also referred to as a received email) received by the management device 100, and divides the email into a body and an attached file based on an analysis result. The storage processing unit 102 stores the body and the attached file of the email divided by the division processing unit 101, and the email structure information in the storage unit 104. Here, the email structure information is information indicating an email structure, and is, for example, a position of a body, a position of an attached file, or header information of a part in which the body or the attached file is embedded in the email.

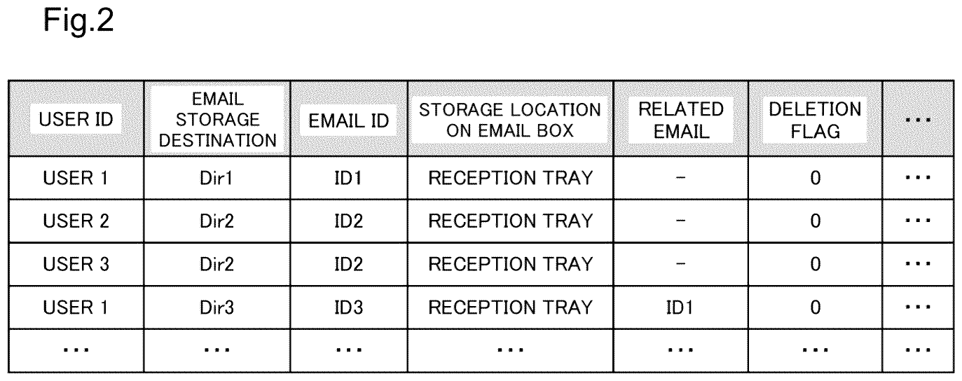

When storing the divided received email in the storage unit 104, the reference information registration processing unit 103 generates reference information for referring to the email and stores the reference information in the reference information storage unit 105. FIG. 2 is a diagram illustrating an example of reference information stored in the reference information storage unit 105. The reference information illustrated in FIG. 2 is a user identifier (ID), an email storage destination, an email ID, a storage location on a user's email box, a related email, and a deletion flag.

The user ID is an identifier of a user who can refer to the email. The reference information registration processing unit 103 identifies the user from the destination of the envelope or header of the received email as the user who can refer to the email, and assigns the user ID. The destination of the envelope or header may include Cc (Carbon Copy) and Bcc (Blind Carbon Copy). The email ID is an identifier of a received email, and is assigned by the division processing unit 101 or the storage processing unit 102 in order of reception. When there is a plurality of destinations in the received email, it is assumed that a plurality of users can refer to the same email, and records of different user IDs are created for the same email ID.

The email storage destination means a storage destination of the storage unit 104 that stores the body and the attached file of the divided email. The storage destination is, for example, folder information of the storage unit 104. The folder information is also referred to as link information. The related email ID is an identifier of the related email representing a stored email related to the received email. When the header information of the received email matches the header information of the stored email, the reference information registration processing unit 103 determines that the received email is related to the stored email. The header information used for the determination is, for example, a set of from/to/cc headers, a references header, and an in-reply-to header.

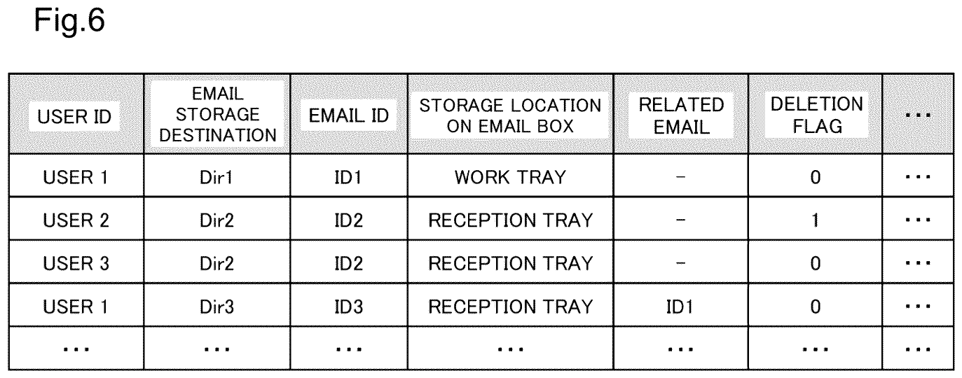

The deletion flag is data indicating that the email has been deleted. In the reference information illustrated in FIG. 6, “0” (email exists) and “1” (email is deleted) are registered as the deletion flags for each record. The items of the reference information are not limited to the above items. For example, a keyword included in header information, a file name, a file path, a body, or an attached file of an email may be included in the reference information in order to improve search performance.

The storage unit 104 stores a body and an attached file of the divided email, and email structure information for each received email. The reference information storage unit 105 stores the above-described reference information. The request processing unit 106 receives an operation request for an email from the terminal 109. As a response to the operation request, an operation result in the operation processing unit 107 is transmitted to the terminal 109. The operation processing unit 107 analyzes the request for an operation of the email stored by the management device 100 and executes an operation process related to the operation request. The operation process is, for example, an email movement, an email deletion, or an email search.

The restoration processing unit 108 acquires the body, the attached file, and the email structure information of the email from the storage unit 104 for the email that has received the operation request from the operation processing unit 107, and restores the email to an email before division. The terminal 109 transmits an operation request to the management device 100 or receives an operation result from the management device 100. The terminal 109 has a function of displaying the content of the body of the email or the attached file. The terminal 109 is, for example, a notebook computer or a smartphone.

Next, an operation of the management device 100 according to the first example embodiment will be described with reference to the drawing. The management device 100 executes a storage process of storing the received email or an operation process on the stored email.

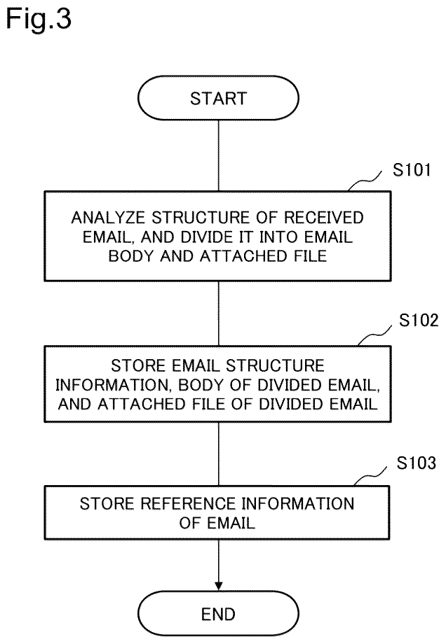

FIG. 3 is a flowchart illustrating an example of an email storage processing by the management device 100. When the management device 100 receives an email, the division processing unit 101 analyzes the email structure of the received email and divides the email into the body and the attached file (step S101). The storage processing unit 102 stores the email structure information indicating the analyzed email structure, the body of the divided email and the attached file of the divided email in the storage unit 104 as separate files (step S102). The reference information registration processing unit 103 stores, in the reference information storage unit 105, reference information in which a storage destination of the received email (the body and the attached file), a user ID indicating the user who can refer to the email, a storage location on the user's email box, a related email, and the like are combined (step S103). As the reference information, a plurality of emails received by the management device 100 is centrally managed.

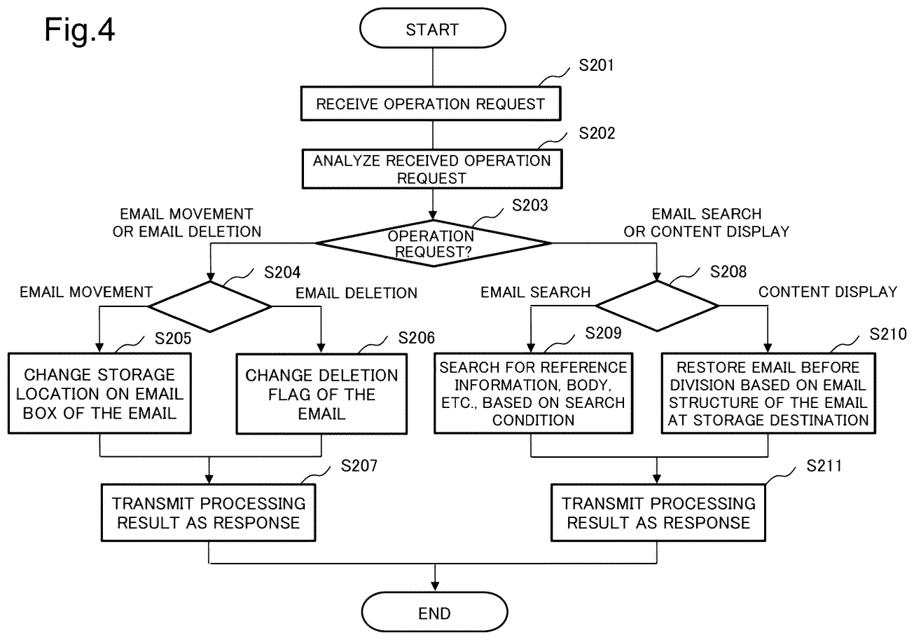

Next, the operation of the management device 100 based on the email operation request will be described with reference to the drawing. FIG. 4 is a flowchart illustrating an example of an email operation process by the management device 100. The request processing unit 106 receives an email operation request from the terminal 109 (step S201). The operation processing unit 107 analyzes the received operation request (step S202). The operation request includes, for example, moving, deleting, searching for, or displaying contents of an email.

The moving of the email is a process of moving the designated email to another email box. When the operation request is the moving of the email, the operation request from the terminal 109 includes the user ID, the email ID indicating it is to be move, and the movement destination information indicating the movement destination of the email. The movement destination information is, for example, a storage location on the email box. The deleting of the email is process of deleting the designated email from the email box. When the operation request is the email deletion, the operation request includes a user ID and an email ID indicating it is to be deleted. The email search is a process of searching for an email stored in the management device 100 using a search condition included in the operation request and outputting a search result. The search result is, for example, the number of emails matching the search condition or a detected email list.

When the analyzed operation request is the email movement or the email deletion (left in step S203), the operation processing unit 107 executes an email operation process by changing the reference information stored in the reference information storage unit 105 based on the operation request.

[Email Movement]

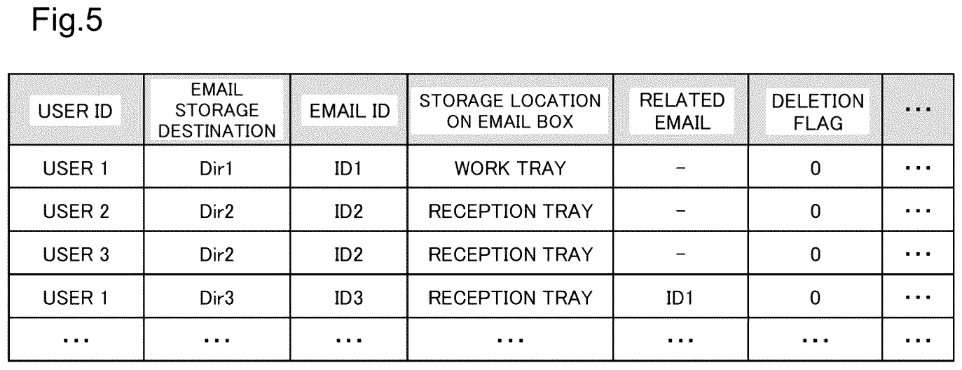

When the operation request is the email movement (left in step S204), the operation processing unit 107 changes the storage location on the email box in the reference information in the reference information storage unit 105 based on the user ID included in the operation request, the email ID indicating the email to be moved, and the movement destination information of the email (step S205). For example, the storage location on the email box related to the user ID (the user 1 in FIG. 5) and the email ID (the ID1 in FIG. 5) in the reference information is changed from the “reception tray” to the “work tray”.

FIG. 5 is a diagram illustrating an example of changing reference information related to the email movement. The storage location on the email box is changed from the “reception tray” to the “work tray” for the email whose email ID is “ID1” in the reference information (FIG. 5) after the email movement, as compared with that in the reference information (FIG. 2) before the email movement. When the user ID and the email ID included in the operation request do not match the user ID and the email ID in the reference information, the operation processing unit 107 ends the operation process without moving the email.

After the operation process of the email movement is completed, the operation processing unit 107 transmits the availability of the email movement to the request processing unit 106. The request processing unit 106 transmits a processing result of the operation request to the terminal 109 (step S207).

[Email Deletion]

When the operation request is the email deletion (right in step S204), the operation processing unit 107 changes the deletion flag of the email in the reference information based on the user ID included in the operation request and the email ID of the email to be deleted (step S206). FIG. 6 is a diagram illustrating an example of changing reference information related to the email deletion. The deletion flag is updated from “0” to “1” for the email related to the user ID (the user 2 in FIGS. 5 and 6) and the email ID (the ID2 in FIGS. 5 and 6) in the reference information after the email deletion (FIG. 6), as compared with that in the reference information before the email deletion (FIG. 5).

When the user ID and the email ID included in the operation request do not match the user ID and the email ID in the reference information, the operation processing unit 107 ends the operation process without deleting the email. In the reference information illustrated in FIG. 6, in a case where a plurality of user IDs is set for the same email ID (for example, the user 2 and the user 3 related to the ID2), the deletion flag associated with the user ID included in the operation request is updated, and the deletion flag associated with another user ID is not updated.

After the email deletion operation process is completed, the operation processing unit 107 transmits the availability of the email deletion to the request processing unit 106 as a processing result. The request processing unit 106 transmits a processing result of the operation request to the terminal 109 (step S207).

Next, when the analyzed operation request is the email search or the email content display (right in step S203), the operation processing unit 107 refers to the reference information storage unit 105 and the storage unit 104 based on the operation request to execute the email operation process.

[Email Search]

When the operation request is the email search (left in step S208), the operation processing unit 107 searches the storage unit 104 and the reference information storage unit 105 based on the user ID and the search condition included in the operation request (step S209) to generate a search result. The search target is the reference information stored in the reference information storage unit 105, or the body, the attached file, or the email structure information of the email stored in the storage unit 104.

For example, the operation processing unit 107 searches for the reference information in the reference information storage unit 105 to extract a record matching the search condition. The operation processing unit 107 further searches the storage unit 104 for the extracted record, and creates a received email list or a file list of the email. However, the email whose deletion flag is updated is not included in the list of search results.

Hereinafter, an example of searching for the attached file of the email by the search condition using the content of the reference information of FIG. 6 will be described. The operation processing unit 107 searches for the reference information using the search condition (user ID, email ID, related email, attached file) included in the operation request. For example, the operation processing unit 107 searches for whether there is a record in which the user ID is the user 1 and the email ID is ID3 in the reference information. In a case where the record exists, it further searched for whether there is an email ID indicating the existence of the related email in the record. In the example in which the email ID is the ID3 in FIG. 6, the presence of the related email whose email ID is the ID1 is detected. The operation processing unit 107 performs the similar process when another user ID and another email ID are included in the operation request. When the related email is not detected, the email search is terminated.

When the related email is detected, the operation processing unit 107 refers to the storage unit 104 based on the email storage destination (Dir1) of the detected related email (ID1), and searches for the attached file of the related email from the stored email structure information. The operation processing unit 107 creates a list of the email title and the file name of the attached file of the related email as the search result of the related email. When there is no attached file, the file name is not included in the search result.

After the operation process of the email search is completed, the operation processing unit 107 transmits the email list and the attached file list generated by the email search to the request processing unit 106 as a processing result. The request processing unit 106 transmits a processing result of the operation request to the terminal 109 (step S211).

[Email Content Display]

When the operation request is the email content display (right in step S208), the operation processing unit 107 searches for the reference information in the reference information storage unit 105 based on the user ID and the email ID of the email included in the operation request, and extracts an email matching the search condition. However, in a case where the deletion flag has been changed, the process is performed as regarded that there is no email.

The restoration processing unit 108 combines the email body and the attached file of the extracted email based on the email structure information in the storage unit 104 for the extracted email and restores the email to an email before division (step S210).

The operation processing unit 107 transmits the content of the restored email to the request processing unit 106 as a processing result, and the request processing unit 106 transmits the content of the email restored as the processing result for the operation request to the terminal 109 (step S211).

According to the management device 100 of the first example embodiment, as described below, it is possible to suppress the index update processing amount while maintaining the performance of searching for the email and the related email.

The management device 100 performs a process of the email movement or the email deletion by updating the reference information in the reference information storage unit 105. As a result, the management device 100 divides and stores the received email into the body and the attached file, generates the reference information associated with the related email, and uses the reference information as the index, thereby suppressing the update processing amount. The management device 100 processes the moving and the deleting of the email by updating the reference information. Therefore, inconsistency does not occur in the content of the index.

The management device 100 of the first example embodiment includes an email ID for identifying a related email related to the email for each record of the reference information. Therefore, even when the related email is moved to another email box, the management device 100 can detect the record of the email of the reference information by tracing the email ID of the related email.

In the management device 100, the division processing unit 101, the storage processing unit 102, the reference information registration processing unit 103, the storage unit 104, the reference information storage unit 105, the request processing unit 106, the operation processing unit 107, and the restoration processing unit 108 each have been described as a single device, but the present disclosure is not limited thereto. There may be a plurality of processing units having the same function. By increasing the processing having the same function, the loads of the respective processing units can be distributed.

The management device 100 does not create an email management file for each user with respect to an email a plurality of addresses of which is broadcasted, but registers the same email ID to the users of the broadcasted email and links the storage destinations as in the reference information illustrated in FIG. 2. As a result, the same email is not redundantly stored in the storage unit 104, and the storage capacity of the storage unit 104 can be suppressed.

### Second Example Embodiment

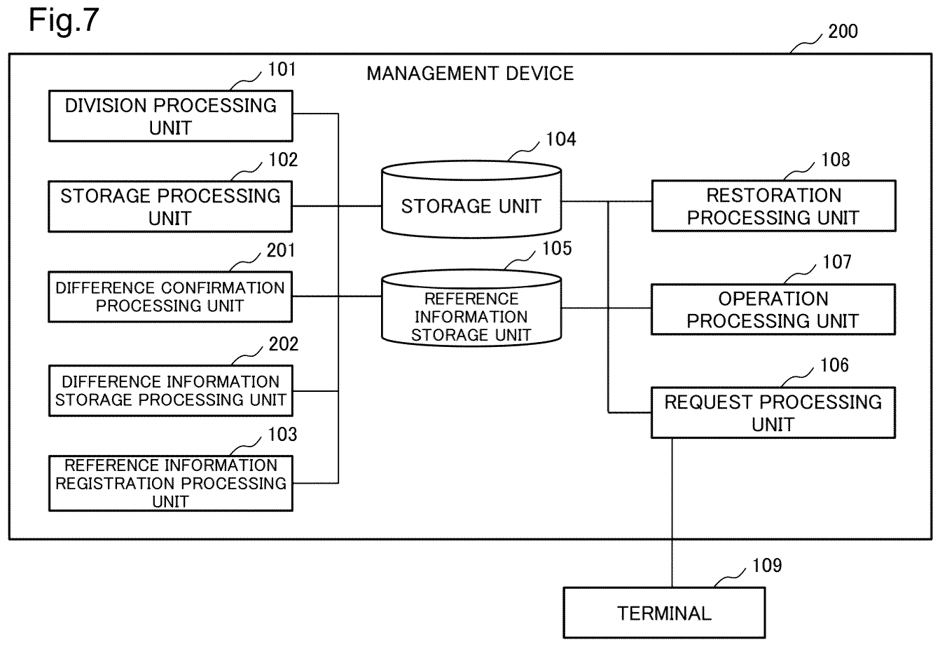

Next, a management device 200 as an aspect of the second example embodiment will be described with reference to the drawing. FIG. 7 is a block diagram illustrating a configuration of the management device 200 according to the second example embodiment. The management device 200 according to the second example embodiment is different from the management device 100 according to the first example embodiment in that it further includes a difference confirmation processing unit 201 and a difference information storage processing unit 202. The function processing units having functions similar to those of the first example embodiment are denoted by the same reference numerals, and detailed description thereof is omitted.

Hereinafter, the difference confirmation processing unit 201 and the difference information storage processing unit 202 of the management device 200 will be described. When the attached file of the email divided by the storage processing unit 102 is stored in the storage unit 104, the difference confirmation processing unit 201 acquires difference information indicating a difference from the attached file already stored in the storage unit 104. The difference information is, for example, a file name, a file type, a file update date and time, a file content, or a file capacity. The difference information storage processing unit 202 stores the acquired difference information in the storage unit 104.

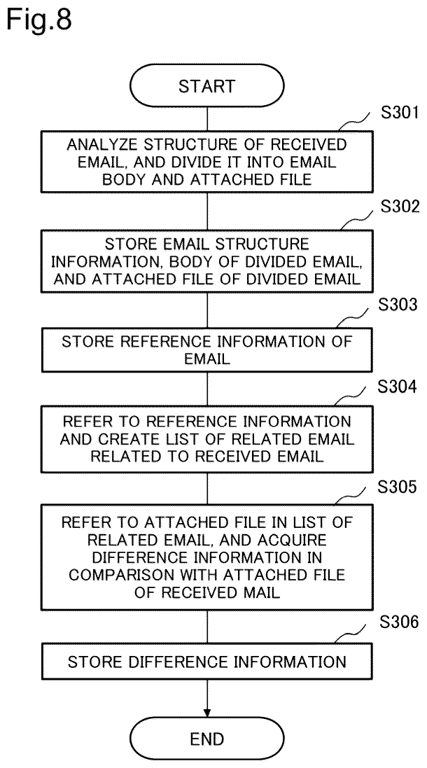

Next, an operation of the management device 200 according to the second example embodiment will be described. FIG. 8 is a flowchart illustrating an example of the storage process of the management device 200 according to the second example embodiment.

Steps S301 to S303 are similar to steps S101 to S103 indicating the email storage operation of the management device 100 according to the first example embodiment, respectively, and thus a detailed description thereof will be omitted.

The difference confirmation processing unit 201 refers to the reference information in the reference information storage unit 105 and creates a list of related emails related to the email (step S304). The difference confirmation processing unit 201 refers to the attached file of the related email list created in step S304, compares the attached file with the attached file of the received email to acquire the difference information (step S305). For example, the difference confirmation processing unit 201 compares a file name of the attached file of the received email with a file name of the attached file of the related email list, and determines the attached file for which the difference is acquired. The method of determining the attached file for which the difference is acquired is not limited to the file name, and may be, for example, a file type or a file update date and time.

The difference information storage processing unit 202 stores the difference information acquired by the difference confirmation processing unit 201 in the storage unit 104 (step S306). The difference information may include information in which the email ID of the email and the email ID of the related email are associated with each other.

According to the management device 200 of the second example embodiment, the difference information created by the difference confirmation processing unit 201 can be added to each search result when there is an operation request for the email search or the email content display from the terminal 109.

### Third Example Embodiment

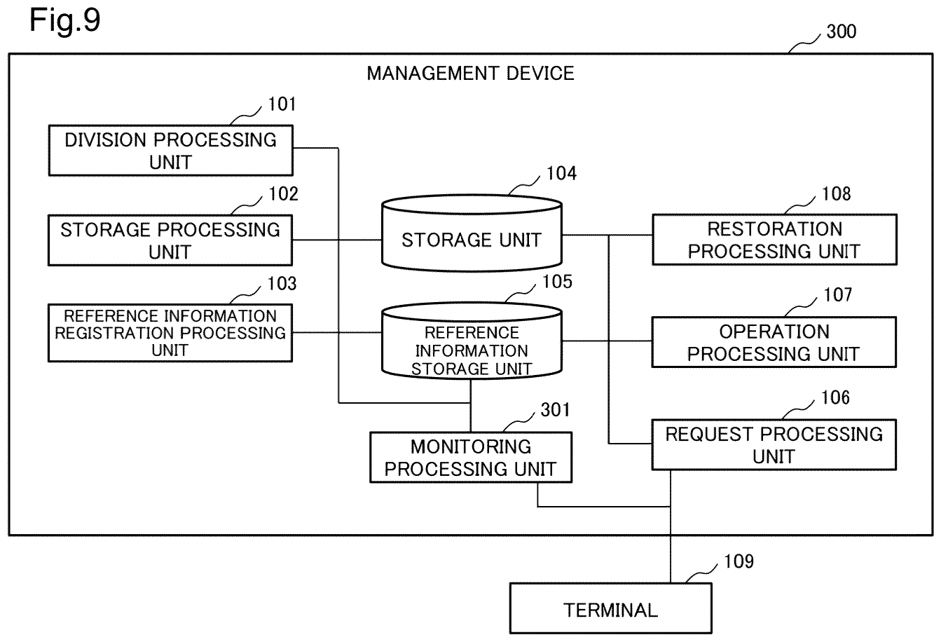

A management device 300 according to an aspect of the third example embodiment will be described with reference to the drawing. FIG. 9 is a block diagram illustrating an example of a configuration of the management device 300 according to the third example embodiment. As illustrated in FIG. 9, the management device 300 includes the division processing unit 101, the storage processing unit 102, the reference information registration processing unit 103, the storage unit 104, the reference information storage unit 105, the request processing unit 106, the operation processing unit 107, the restoration processing unit 108, and a monitoring processing unit 301. The terminal 109 is communicably connected to the management device 300.

The management device 300 according to the third example embodiment has a configuration in which the monitoring processing unit 301 is added to the management device 100 according to the first example embodiment. In the description of the management device 300 according to the third example embodiment, the same components as those of the management device 100 according to the first example embodiment are denoted by the same reference numerals, and detailed description thereof is omitted.

In the management device 300, the monitoring processing unit 301 is connected to the storage unit 104 and the reference information storage unit 105, and has a function of referring to the body of the email stored in the management device 300 or the attached file of the email stored in the management device 300.

The terminal 109 transmits a request to monitor the email and the reference information stored in the management device 300 to the monitoring processing unit 301. It is assumed that an administrator ID is given to a system administrator of the management device 300, and the administrator ID is given an authority capable of referring to and monitoring an email (a body and an attached file) of the user ID registered in the reference information. The monitoring processing unit 301 refers to the reference information in the reference information storage unit 105 and the body and the attached file stored in the storage unit 104 based on the monitoring request received from the terminal 109. The monitoring processing unit 301 may have a function of restoring the referred body and attached file to the email before division based on the email structure information. The monitoring processing unit 301 transmits the monitoring result to the terminal 109 as a response to the monitoring request.

According to the management device 300, the monitoring processing unit 301 allows the system administrator to refer to the body and the attached file of the email stored in the storage unit 104, and to use the result in order to check detection of spam email and information leakage.

(Hardware Configuration)

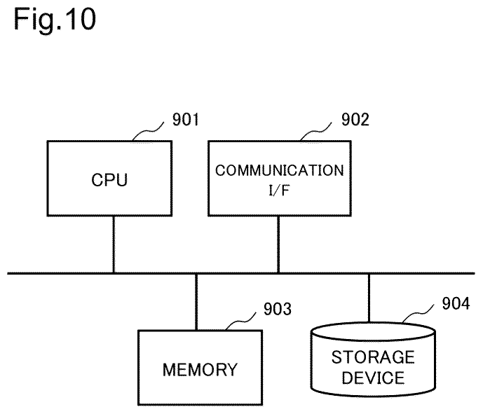

At least part of the management device 100, 200, 300 described above may be achieved by executing a program (software) by a central processing unit (CPU) 901 of a computer illustrated in FIG. 10. For example, the management device 100 according to the first example embodiment can be achieved by executing a program that causes processes of the division processing unit 101, the storage processing unit 102, the reference information registration processing unit 103, the request processing unit 106, the operation processing unit 107, and the restoration processing unit 108 to function. These components may be achieved by the CPU 901 reading a program from the memory 903 or the storage device 904 and executing the read program using the CPU 901 and the memory 903 as in the procedure of the flowcharts illustrated in FIGS. 2 and 4, for example. In such a case, the above-described example embodiment can be regarded as being configured by a code representing a computer program or a computer-readable storage medium in which the code representing the computer program is stored. The computer-readable storage medium is, for example, the storage device 904, a removable magnetic disk medium (not illustrated), an optical disk medium (not illustrated), or the like. Transmission and reception of data with the computer are performed via a communication interface (I/F) 902. At least part of the components of each example embodiment may be dedicated hardware by an integrated circuit.

In the present disclosure, the present disclosure is not limited to the above-described example embodiments. Various modifications can be made to each example embodiment, and example embodiments obtained by appropriately combining configurations, operations, and processes disclosed in different example embodiments are also included in the technical scope of the present disclosure.

For example, the management device of each example embodiment can be applied to a device that uses an email field, an archive field, an email filtering function, and a file management function.

This application is based upon and claims the benefit of priority from Japanese patent application No. 2019-203665 filed on Nov. 11, 2019, the disclosure of which is incorporated herein in its entirety by reference.

### REFERENCE SIGNS LIST

101 division processing unit
102 storage processing unit
103 reference information registration processing unit
104 storage unit
105 reference information storage unit
106 request processing unit
107 operation processing unit
108 restoration processing unit
109 terminal
201 difference confirmation processing unit
202 difference information storage processing unit

What is claimed is:

1. A management device comprising:
a memory storing instructions; and
one or more processors configured to execute the instructions to:
divide a received email into a body and an attached file;
store the body, the attached file, and email structure information indicating an email structure of the email in a storage;
generate reference information in which link information indicating a storage destination of the divided email is associated with a related email related to the email, and store the reference information in a reference information storage;
accept an operation request for the stored email; and
perform an operation of moving, deleting, searching for, or displaying a content of the stored email based on the operation request.

2. The management device according to claim 1, wherein the one or more processors are further configured to execute the instructions to:
restore the stored body and the stored attached file to an email before division based on the email structure information.

3. The management device according to claim 1 wherein the one or more processors are further configured to execute the instructions to:
acquire difference information indicating a difference between an attached file already stored in the storage and the divided attached file when the divided attached file is stored in the storage; and
store the difference information in the storage.

4. The management device according to claim 1, wherein the one or more processors are further configured to execute the instructions to:
refer to the reference information in the reference information storage, and the body and the attached file stored in the storage based on a monitoring request received from a terminal.

5. The management device according to claim 1 wherein the one or more processors are further configured to execute the instructions to:
when the operation request corresponds to the moving of the email,
change a storage location on an email box of the email on which an operation is to be performed, the storage location being included in the reference information, to a storage location included in the operation request.

6. The management device according to claim 1 wherein the one or more processors are further configured to execute the instructions to:
when the operation request corresponds to the deleting of the email,
change a deletion flag indicating the deleting of the email on which an operation is to be performed, the deletion flag being included in the reference information.

7. The management device according to claim 1 wherein
the one or more processors are further configured to execute the instructions to:
when the operation request corresponds to the searching for the email,
search for the reference information or the storage destination based on a search condition of the operation request.

8. The management device according to claim 2, wherein
the one or more processors are further configured to execute the instructions to:
when the operation request corresponds to the displaying the content of the email,
search for the reference information based on a search condition of the operation request and extract the email matching the search condition, and
restore the body and the attached file in the storage means in which the extracted email is stored to the email before division based on the email structure information.

9. A management method comprising:
dividing a received email into a body and an attached file;
storing the body, the attached file, and email structure information indicating an email structure of the email;
generating and storing reference information in which link information indicating a storage destination of the divided email is associated with a related email related to the email;
accepting an operation request for the stored email; and
performing an operation of moving, deleting, searching for, or displaying a content of the stored email based on the operation request.

10. A recording medium storing a program causing a computer to execute:
dividing a received email into a body and an attached file;
storing the body, the attached file, and email structure information indicating an email structure of the email;
generating and storing reference information in which link information indicating a storage destination of the divided email is associated with a related email related to the email;
accepting an operation request for the stored email; and
performing an operation of moving, deleting, searching for, or displaying a content of the stored email based on the operation request.
